(19) United States
(12) Patent Application Publication
(10) Pub. No.: US 2012/0284071 A1
(43) Pub. Date: Nov. 8, 2012

(54) RETAIL PRE-PACK OPTIMIZATION SYSTEM

(75) Inventor: Andrew Vakhutinsky, Norwood, MA (US)

(73) Assignee: ORACLE INTERNATIONAL CORPORATION, Redwood Shores, CA (US)

(21) Appl. No.: 13/101,539

(22) Filed: May 5, 2011

(51) Int. Cl. G06Q 10/00

(52) U.S. Cl. 705/7.12

(57) ABSTRACT

A system for determining an optimized pre-pack solution receives demand data and constraints and initializes a current pre-pack configuration comprising a current pre-pack design that comprises a plurality of pre-pack types, each pre-pack type comprising one or more different products. The system optimizes a pre-pack allocation based on the current pre-pack configuration and determines an objective function value improvement comprising, for each product in each pre-pack type, changing a level of the product by one unit and determining if the objective function value has improved. If the objective function value has improved, the system generates a new pre-pack design based on the changed level of the product and assigns the new pre-pack design as the current pre-pack design and re-optimizes the allocation. The system repeats until the objective function value stops improving. The system then outputs an optimized pre-pack configuration and optimized pre-pack allocation.

### FIELD

One embodiment is directed generally to a computer system, and in particular to a computer system for optimizing retail pre-packs.

### BACKGROUND INFORMATION

A “pre-pack” is a collection of items used in retail distribution. The pre-pack is a group of multiple units of one or more stock keeping units (“SKU”) that can reduce distribution and handling costs, by reducing the amount of material handled at the origin (e.g., a distribution center), destination (e.g., a retail store), and intermediate points (e.g., a warehouse).

For example, apparel retailers typically construct pre-packs of various sizes of a particular style and color of a t-shirt, rather than directly ship loose quantities of each size to stores. There can be multiple pre-pack “types” or “designs”, each having different quantities of individual products and in different relative proportions, and the collection of the different pre-pack types is referred to as an overall pre-pack “configuration.” An example of one pre-pack type is a pre-pack having 5 extra small t-shirts, 10 small t-shirts, 15 medium t-shirts, 15 large t-shirts, and 10 extra large t-shirts. An example of a second pre-pack type is a pre-pack having 10 extra small t-shirts, 15 small t-shirts, 10 medium t-shirts, 10 large t-shirts, and 5 extra large t-shirts. An example of a pre-pack configuration is 10 of the first pre-pack type and 5 of the second pre-pack type.

The pre-packs are configured when the demand forecast for merchandise items becomes known at the store level. At this point, several similar items are grouped to be jointly delivered to the stores by one or more pre-packs to reduce delivery costs. However, there is a certain tradeoff to pre-packs. Specifically, performing such an aggregation while reducing shipping and handling costs tends to increase the mismatch between the required quantity of each individual merchandise at the destination and what is actually shipped (i.e., either an over- or under-allocation), given that there are typically a maximum number of pre-pack types employed.

For example, suppose there is a demand at a store for fifteen t-shirts of size “small” but the pre-pack type contains ten “small” t-shirts. In this example, either ten or twenty units can be delivered to the store, depending on a configuration of one of these pre-packs or two pre-packs, resulting in either an under- or over-allocation of small t-shirts at the store. As a result, the determination of a pre-pack configuration and pre-pack types should be optimized to minimize the total of delivery and misallocation costs subject to various pre-pack constraints.

### SUMMARY

One embodiment is a system for determining an optimized pre-pack solution. The system receives demand data and constraints and initializes a current pre-pack configuration comprising a current pre-pack design that comprises a plurality of pre-pack types, each pre-pack type comprising one or more different products. The system optimizes a pre-pack allocation based on the current pre-pack configuration and determines an objective function value improvement comprising, for each product in each pre-pack type, changing a level of the product by one unit and determining if the objective function value has improved. If the objective function value has improved, the system generates a new pre-pack design based on the changed level of the product and assigns the new pre-pack design as the current pre-pack design and re-optimizes the allocation. The system repeats until the objective function value stops improving. The system then outputs an optimized pre-pack configuration and optimized pre-pack allocation.

### BRIEF DESCRIPTION OF THE DRAWINGS

FIG. 1 is a block diagram of a computer system that can implement an embodiment of the present invention.

FIG. 2 is a flow diagram of the functionality of the pre-pack optimizer module of FIG. 1 when determining an optimized pre-pack design in accordance with one embodiment.

### DETAILED DESCRIPTION

One embodiment is a computer system that optimizes both the pre-pack types and the pre-pack configuration. The system alternatively optimizes the pre-pack allocation for a given pre-pack configuration to improve the value of an objective function, and based on the allocation, further improves the objective function value by changing the amount of one or two products by one unit in each pre-pack while keeping the allocation constant. An optimized pre-pack configuration is generated when the objective function value can no longer be improved.

In general, a “pre-pack” is a collection of units of various SKUs bundled together, as described above. A pre-pack can be represented as follows: {SKU1: quantity of SKU1, SKU2: quantity of SKU2, SKU3: quantity of SKU3, . . . }. Typically all SKUs from a given pre-pack belong to the same style-color, or to the same style, or to several styles from same class.

A pre-pack “type” is a unique “flavor” of a pre-pack characterized by a certain set of SKUs and a certain set of corresponding unit quantities. A pre-pack “configuration” is a set of unique pre-pack types used as shipment units to allocate a particular style-color (or style, or a group of styles) to all stores.

Pre-pack constraints are certain business constraints on pre-pack types and configurations, such as the total number of units in a pre-pack is within certain min/max or equals certain carton sizes, etc. Constraints can be “hard” or “soft” constraints. Hard constraints are those business rules that must be satisfied (e.g., no more than three pre-pack types must be used in the configuration). Soft constraints are those business rules that must be satisfied to the extent possible. Typically these are equivalent to the objectives and goals of a business (e.g., minimize misallocation to the extent possible).

A feasible pre-pack configuration is a pre-pack configuration that satisfies all pre-pack hard constraints. A pre-pack allocation for a given sku-parent, store, and feasible pre-pack configurations can be represented as follows: {pre-pack type 1: quantity of pre-packs of type 1, . . . , pre-pack type N: quantity of pre-packs of type N}

Embodiments of the present invention perform pre-pack optimization by creating a pre-pack configuration for a given style-color (or style, or a group of styles) that satisfies business constraints (e.g., on the number of unique pre-pack types in pre-pack configuration and on the number of units in a pre-pack configuration) so that the resulting pre-pack configuration can be used to allocate that style-color (or style, or a group of styles) to all stores in such a way that some weighted sum of misallocation (i.e., lost sales, handling costs and markdown losses) is minimized across all stores, while also limiting the number of used unique pre-pack types and the total number of pre-packs allocated, thereby minimizing operational and shipping, and handling costs.

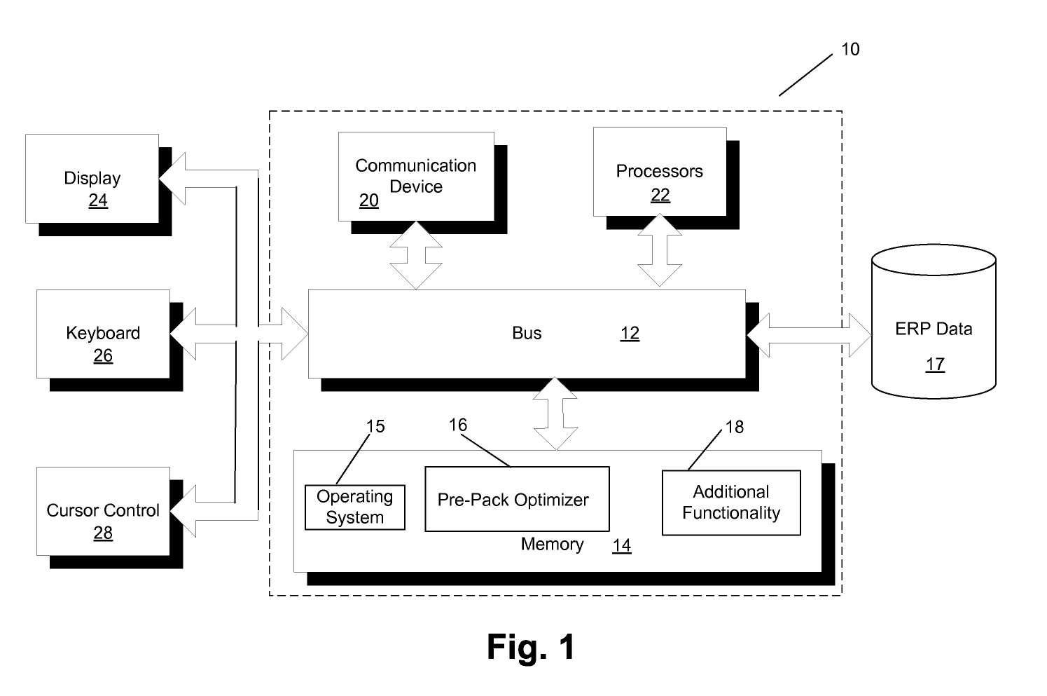

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor capable of processing multiple instructions in parallel. In one embodiment, processor 22 is an individual multi-core processor, but may be implemented using multiple individual processors in communication with each other, or any other type of processor or processors that is capable of parallel computing.

System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a pre-pack optimizer module 16 that optimizes pre-pack types and configurations/allocations, as disclosed in more detail below. System 10 can be part of a larger system, such as an overall retail management system or an Enterprise Resource Planning (“ERP”) system. Therefore, system 10 will typically include one or more additional functional modules 18 to include the additional functionality. A database 17 is coupled to bus 12 to provide centralized storage for modules 16 and 18 and store data such as retail pricing and inventory information, other ERP data, etc.

In one embodiment, pre-pack optimizer module 16 receives inputs and generates as outputs an optimized and feasible pre-pack design that includes the design of each of the pre-pack types, and the pre-pack configuration. The inputs can include store-level demands for D stores, for a given set of Q SKUs, specified as a D×Q matrix, and further includes P (variable or fixed number) of pre-packs, pre-pack hard constraints and soft constraints (i.e., objectives and goals). In one embodiment, the input data is in a dense two-dimensional matrix form. In another embodiment, the input data can be in a sparse matrix form that only specifies the non-zero demand values.

The output in one embodiment is a feasible, good-quality pre-pack configuration and pre-pack designs (one solution or a family of solutions for different numbers of pre-pack types used) that satisfies all pre-pack hard constraints (if feasible) and meets soft constraints to the extent possible.

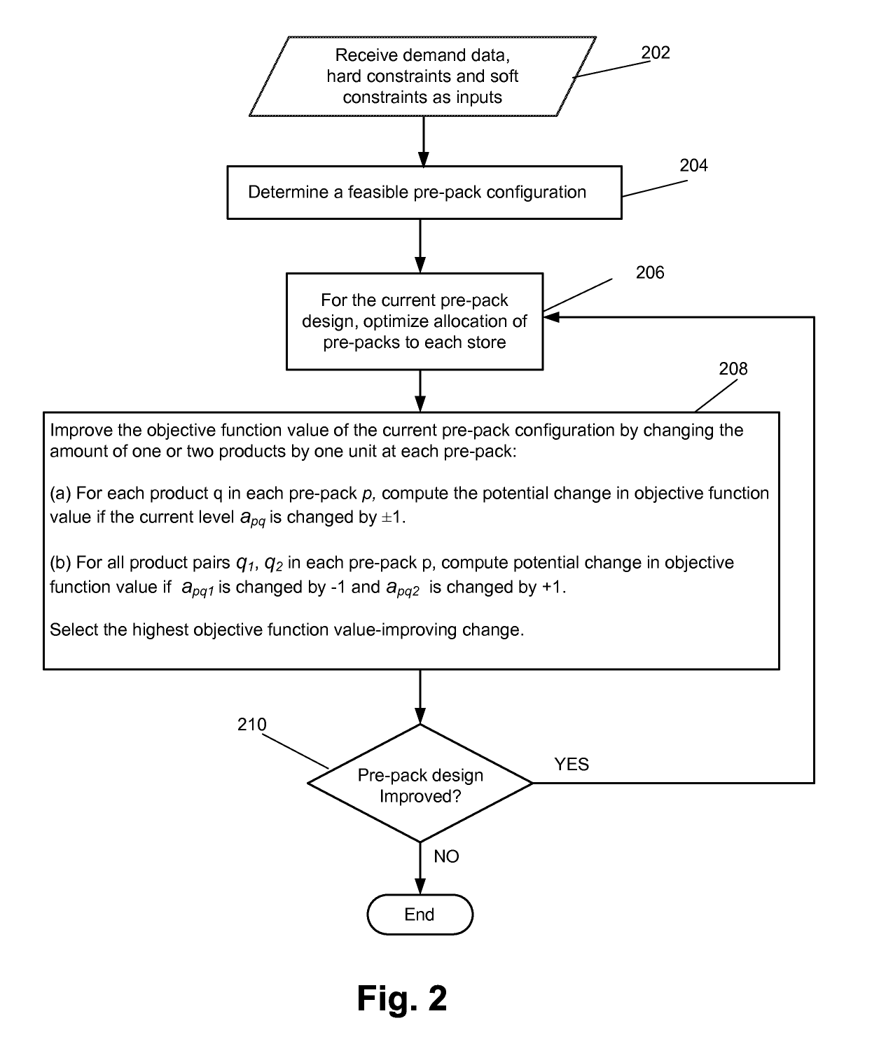

FIG. 2 is a flow diagram of the functionality of pre-pack optimizer module 16 of FIG. 1 when determining an optimized pre-pack design in accordance with one embodiment. In one embodiment, the functionality of the flow diagram of FIG. 2 is implemented by software stored in memory or other computer readable or tangible medium, and executed by a single processor or multiple processors in parallel. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

One output of the functionality of FIG. 2 is the best sku-level composition of pre-packs in order to satisfy sku-level store demands in the optimal way subject to allocation and pre-pack constraints. Possible optimality criteria includes the total number of packs delivered+eaches, or the total store misallocation. Store allocation constraints include maximum over-allocation (per-store or per-chain), presentation maximum, and shipping minimum. Pre-pack constraints include maximum/minimum pre-pack size, maximum number of sku's in a pack, and maximum number of pre-packs per sku/sku group.

The problem formulation for FIG. 2 can be expressed as follows:

SKU set, q=1, . . . , Q

Pack types, p=1, . . . , P; type p contains a_{pq} items of sku q

Stores, j=1, . . . , N

Pack-to-store allocations, xⱼₚ

Decision variables: a_{pq}, xⱼₚ,

Objective function: f(a_{pq}, xⱼₚ)

Minimize: f(a_{pq}, xⱼₚ)

Subject to constraints

At 202, the demand data, hard constraints and soft constraints are received as inputs. In one embodiment, these inputs can be in the form of a matrix.

At 204, a feasible initial pre-pack configuration, which includes a pre-pack design having a number of different pre-pack types, is determined or received. One embodiment for determining a feasible pre-pack configuration is disclosed below.

At 206, for the current or new pre-pack design, the allocation of pre-packs to each store is optimized. In one embodiment, an allocation algorithm, discussed in detail below, is used to optimize the current allocation based on the new pre-pack design. The result at 206 is a solution to a misallocation minimization problem that can be expressed as:

$$PPP \text{:} Minimize {\sum }_{q = 1}^{Q} {\sum }_{j = 1}^{D} ( {y}_{qj}^{+} + {y}_{qj}^{-} )$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$$L \leq {\sum }_{q} {a}_{pq} \leq U , ∀ p = 1 , … , T . \\ x \geq 0 , a \geq 0 , y \geq 0$$

$$x , a integer .$$

At 208, an attempt is made to improve an objective function value of the current or initial pre-pack configuration by changing the amount of one or two products by one unit at each pre-pack. This is done using two different methods: (a) for each product q in each pre-pack p, the potential change in the objective function value is determined if the current level a_{pq} is changed by ±1; (b) for all product pairs q₁, q₂ in each pre-pack p, the potential change in the objective function value is determined if a_{pq1} is changed by −1 and a_{pq2} is changed by +1. The highest objective function value-improving change is then determined by determining which resulted in the greatest positive change.

At 210, it is determined if the pre-pack design was improved based on the determinations of 208. If no at 210, the functionality ends and the current design and allocation is the optimized pre-pack solution because the allocation and design can no longer be “improved” in accordance with parameters. If yes at 210, the improved pre-pack design is the new current pre-pack design and the functionality continues at 206.

The functionality of FIG. 2, as performed by pre-pack optimizer module 16 of FIG. 1, can be referred to as a “pseudo-gradient” method/algorithm because a single-SKU moves along pseudo-gradients. It relies on allowing only unitary changes to individual variables in pre-pack design.

One embodiment starts with a feasible initial solution (a,x) and attempts to improve current pre-pack design a, while keeping the x-variables constant. Pre-pack a-variables are then fixed, allocation optimization is performed, and the algorithm reiterates.

Embodiments assume the pre-packs are allocated to the stores to satisfy the per-store targets. The amount of per-store-per-SKU misallocation is denoted by y_{jq}⁻ or y_{jq}⁺ depending on whether it is under- or over-allocation. Consider the effect of increasing a specific pack component a_{pq} by one unit, a_{pq}→a_{pq}+1. In this case, if a store target for a specific SKU is over-allocated, then the over-allocation is increased by xₚⱼ; otherwise, if the target is under-allocated, the misallocation is changed depending on the relative sizes of xₚⱼ and y_{jq}⁻: Δ_{jq}=max(xₚⱼ−y_{jq}⁻, 0)−min(xₚⱼ, y_{jq}⁻). This also covers the case of over-allocation. If the total change of the objective function associated with a_{pq} increase by one unit is denoted as grad_{pq}⁺, then

$${grad}_{pq}^{+} = {\sum }_{j = 1}^{D} ( {c}_{1} max ( {x}_{pj} - {y}_{jq}^{-} , 0 ) - {c}_{2} min ( {x}_{pj} , {y}_{jq}^{-} ) )$$

Similarly, the total change of the objective function associated with a_{pq} decrease by one unit is denoted by grad_{pq}⁻ and

$${grad}_{pq}^{-} = {\sum }_{j = 1}^{D} ( {c}_{2} max ( {x}_{pj} - {y}_{jq}^{+} , 0 ) - {c}_{1} min ( {x}_{pj} , {y}_{jq}^{+} ) )$$

The pseudo-gradient method of FIG. 2, also disclosed below, improves the current pack allocation solution by changing the pre-pack design, one or two items at a time. The current solution is assumed to be feasible, subject to lower (L) and upper (U) bounds of the pack size.
1. for all

$$q , p \text{:} {\sum }_{q = 1}^{Q} {a}_{pq} > L ,$$

find gradₘᵢₙ=min grad_{pq}⁻; if gradₘᵢₙ<0, decrease corresponding a_{pq} by one unit and re-optimize allocation;
2. for all

$$q , p \text{:} {\sum }_{q = 1}^{Q} {a}_{pq} < U$$

find gradₘᵢₙ=min grad_{pq}⁺; if gradₘᵢₙ<0, increase corresponding a_{pq} by one unit and re-optimize allocation;
3. If the first two searches fail, find p: min_{q} grad_{pq}⁺+min_{q} grad_{pq}⁻<0; simultaneously increase a_{pq+} and decrease a_{pq-} by one unit and re-optimize the allocation.
   In one embodiment, when the pre-pack size (i.e., number of units) is fixed, only step 3 above is used.

The above three steps are iterated as long as at least one of them can be performed successfully. Otherwise, it is determined that the current solution cannot be improved anymore by the pseudo-gradient search method and the method is terminated and the best solution is outputted.

### Inputs

In one embodiment, the following inputs are provided to pre-pack optimizer 16 of FIG. 1:
Minimum and Maximum number of pre-packs (a pair of integers).
SKU store demand (a 2D vector or matrix, which could be a sparse matrix).
Bounds on SKU quantities in each pack (l_{pq}, u_{pq}) for each pre-pack type p, SKU q (all integers).
Bounds on total quantity in each pack (Lₚ, Uₚ) for each pre-pack type p (all integers).
Carton size parameter (e.g., multiples of ‘k’, powers of 2, etc.), all integers or ENUM. An integer list of all feasible pack-size values between (Lₚ, Uₚ) can be directly specified as inputs for each pre-pack type.
Objective function weights or priorities (cᵢ) or soft constraints (all floating point).

### Outputs

In one embodiment, the following outputs are generated by pre-pack optimizer 16 of FIG. 1:

Pack contents 2-D matrix a_{pq}, one entry for each sku-pack combination p, q.

Allocations (xₚⱼ), one entry for each pack-store combination p, j.

### Hard Constraints

In one embodiment, the following hard constraints are received by pre-pack optimizer 16 of FIG. 1 at 202 of FIG. 2:
Min and Max number of pre-pack types in the configuration.
Min and Max number of total units for each pre-pack type. It is possible to specify a unique min/max for each pre-pack type.
Min and max number of units of each sku in each pre-pack type (i.e., range constraints). It is possible to specify a unique pair of values for each sku for every pre-pack type. These range constraints allow fine-grain control over the contents of every pre-pack type (e.g., packs with fringe-sizes only).
Carton-size “ladder”. This specifies the allowable values for the feasible number of total units per pre-pack type. For example, even numbers, multiples of 4, powers of 2, or any integer value.

### Soft Constraints

In one embodiment, the following soft constraints (i.e., business objectives) are received by pre-pack optimizer 16 of FIG. 1 at 202 of FIG. 2:
Minimize a configurable (parameterized) weighted dollar-value measure of total under-allocation (U), over-allocation (O), total number of packs shipped (S) summed across all stores, skus, and pack-types, and a pre-pack type ‘complexity’ cost (c₀), summed across all pre-pack types (P) and is given by:

c₀*P+c₁*U+c₂*O+c₃*S,
where c₀, c₁, c₂, and c₃ are user-specified priority or cost parameters (real numbers). c₃ can be assumed to represent the shipping cost for a single unit, regardless of whether it is a loose unit (eaches) or a pre-pack. U (for a given sku-store combination) is defined as the simple arithmetic difference between the demand (d) minus the allocation of sku-units to a store (A) when A<d, and zero, otherwise, i.e.,

U=Max(0, d−A). Similarly, for a given sku-store combination,

O=Max(0, A−d).

### Optimization Model

In one embodiment, pre-pack optimizer 16 of FIG. 1 uses the following optimization model instead of the pseudo-gradient method shown in FIG. 2. This model assumes the number of pre-pack types is not known in advance.

### Input Data Notation:

d_{jq}=demand for a given sku q at store j.
(m, M)=min and max number of pre-pack pack types allowed.
(Lₚ, Uₚ)=min and max number of units in pre-pack p.
(l_{pq}, u_{pq})=min and max number of units of sku q in pre-pack p.
Z={Z₁, Z₂, . . . , Z_{N}} set of feasible carton-sizes.
c₀=Dollar cost of introducing an additional pre-pack type.
c₁=Dollar cost of one unit of under-allocation of any sku at a store.
c₂=Dollar cost of one unit of over-allocation of any sku at a store.
c₃=Dollar cost of shipping a pre-pack to a store.

### Decision Variables:

xₚⱼ=# of units of pre-pack type p to allocated to store j (integer).
wₚ=binary (indicator) variable that is positive if pre-pack type p is active (chosen) in the optimal solution.
a_{pq}=# of units of sku q in pre-pack type p, and should be within the range (l_{pq}, u_{pq})
For convenient model presentation, an auxiliary decision variables z are used, which are derived from the aggregation of a-variables:
zₚ=# of units in pre-pack type p.

### Mixed-Integer Nonlinear Program:

In one embodiment, the pre-pack planning problem can be expressed as the following nonlinear integer program “PPP”, which includes additional auxiliary variables y⁺, and y⁻ to represent sku-store level under- and over-allocation amounts respectively.

$$PPP : Minimize {\sum }_{p} {c}_{0} {w}_{p} + {\sum }_{q = 1}^{Q} {\sum }_{j = 1}^{D} ( {c}_{1} {y}_{qj}^{+} + {c}_{2} {y}_{qj}^{-} ) + {c}_{3} {\sum }_{j} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$${\sum }_{q} {a}_{pq} = {z}_{p} , ∀ p$$

$${l}_{pq} {w}_{p} \leq {a}_{pq} \leq {u}_{pq} {w}_{p}$$

$${L}_{p} {w}_{p} \leq {z}_{p} \leq {U}_{p} {w}_{p}$$

$$m \leq {\sum }_{p} {w}_{p} \leq M$$

$$a , x , y , z , w \geq 0$$

$$z ∈ Z$$

$$x , a integer$$

$$w binary$$

PPP has a hierarchical nature of decision-making (w→z→a→x→y). A consequence of this daisy-chain of decision variables is that the number of possibilities in the solution space increases exponentially in the length of this chain. Further, the bilinear terms (a, x) in the first set of constraints further complicate the model by injecting increased non-convexity into the model. In general, PPP is difficult to solve to optimality, either directly or even indirectly via integer linear reformulations, including generating-set based approaches (e.g., column generation) for many practical instances. Consequently, embodiments use the pseudo-gradient approach shown in FIG. 2. In general, the number of pre-pack types considered is typically small (less than 10) and thus, it is easier to solve PPP sequentially for each allowed values for the number of pre-pack types in the configuration and select the best solution among these results.

For a fixed number of pre-pack types (i.e., the number of pre-pack types is known in advance):

P=# of pre-pack types in the configuration,

the w-variables and the constraints involving these variables can be eliminated, and the resultant “working model” PPP(P) is shown below.

$$PPP ( P ) \text{:} Minimize {\sum }_{q = 1}^{Q} {\sum }_{j = 1}^{D} ( {c}_{1} {y}_{qj}^{+} + {c}_{2} {y}_{qj}^{-} ) + {c}_{3} {\sum }_{j} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$${\sum }_{q} {a}_{pq} = {z}_{p} , ∀ p$$

$$a , x , y , z \geq 0$$

$${l}_{pq} \leq {a}_{pq} \leq {u}_{pq}$$

$${L}_{p} \leq {z}_{p} \leq {U}_{p}$$

$$z ∈ Z$$

$$x , a integer$$

### Finding an Initial Feasible Solution that Meets all Hard Constraints

In one embodiment, such as 204 of FIG. 2 above, an initial feasible solution determines a good value for the total number of SKU units in each pre-pack type (z-variables in PPP) such that a good match is obtained between total sku-parent level demand and pre-packs. Toward this, the PPP is solved at a higher-level of demand aggregation, i.e., solve a single sku-parent level problem whose store-level demand=sum of all SKU-level demands for that store, as shown below.

$$1 - PPP \text{:} Minimize {\sum }_{j = 1}^{{D}^{′}} ( {c}_{1} {y}_{j}^{+} + {c}_{2} {y}_{j}^{-} ) + {c}_{3} {\sum }_{j} {\sum }_{p} {x}_{pj}$$

$$subject to \text{:}$$

$${\sum }_{p} {z}_{p} {x}_{pj} + {y}_{j}^{+} - {y}_{j}^{-} = {\sum }_{q} {d}_{qj} ∀ j$$

$$x , y , z \geq 0$$

$${L}_{p} \leq {z}_{p} \leq {U}_{p}$$

$$z ∈ Z$$

$$x , z integer$$

### Allocation Algorithm

In one embodiment, a cost for each pre-pack p is determined, such as shown in 208 of FIG. 2 above and an allocation algorithm is used in 206 of FIG. 2. Given a fixed pre-pack configuration, this allocation algorithm determines the optimal allocation of each pack-type sequentially by store.

The problem for allocation algorithm ‘A’ can be formulated as:

$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$${y}_{qj} \geq 0 , ∀ q , j$$

$${x}_{pj} \geq 0 and integer ∀ p , j$$

$${x}_{pj} ∈ {X}_{j}$$

where Xⱼ is a feasible set of assignment variables associated with store j. It may be determined by such constraints as shipping minimum, presentation maximum, and over-allocation limit. These constraints can be expressed as:

$${\sum }_{q = 1}^{Q} {\sum }_{p} {a}_{pq} {x}_{pj} \geq {S}_{j}$$

$${\sum }_{q = 1}^{Q} {\sum }_{p} {a}_{pq} {x}_{pj} \leq {P}_{j}$$

$${\sum }_{q = 1}^{Q} max ( {\sum }_{p} {a}_{pq} {x}_{pj} - {d}_{qj} , 0 ) \leq {O}_{j}$$

where Sⱼ, Pⱼ, and Oⱼ are shipping minimum, presentation maximum and over-allocation limit, respectively, for store j.
Other, more exotic per-store constraints may be present in the formulation. Since the problem does not have inter-store binding constraints, it can be easily decomposed to be solved on a per-store basis. The per-store allocation problem then becomes:

$$Allocation per store j \text{:} Minimize {\sum }_{q = 1}^{Q} ( {c}_{1} \cdot {y}_{qj}^{+} + {c}_{2} \cdot {y}_{qj}^{-} ) + {c}_{3} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$${y}_{qj} \geq 0 , ∀ q , j$$

$${x}_{pj} \geq 0 and integer ∀ p , j$$

$${x}_{pj} ∈ {X}_{j}$$

Since the number of pre-pack types is typically relatively low (at most 10) in some embodiments, the solution to the per-store allocation problem can be obtained by “almost” complete enumeration, which means that in the worst case all feasible solutions will be generated in order to select the optimal solution. However, a number of filters can be applied that significantly reduce the number of the solutions to generate. The solution process starts with x-vector with all zeroes and goes through P iterations. At iteration p, the set of current vectors is doubled by adding vectors with 1 in the p-th position to the vectors in the current set, which by design have 0 in the p-th position. Then the filters are applied and the process reiterates by adding vectors with 1 in the p+1 position. There are three groups of filters that are applied with the objective function and constraints in one embodiment as described below:
1. Current infeasibility filter: If either presentation maximum or over-allocation limit constraint is violated for a store allocation vector, they will be also violated for all its descendants generated by adding more 1's.
2. Sub-optimality filter: If all y⁻=0, i.e., there is no under-allocation and c₂+c₃>0, then all future descendants of the store allocation vector will have higher cost and thus be suboptimal.
3. Shipping minimum filter: If at iteration p′ the following is true:

$${\sum }_{q = 1}^{Q} {\sum }_{p = 1}^{{p}^{′}} {a}_{pq} {x}_{pj} + {\sum }_{q = 1}^{Q} {\sum }_{p = {p}^{′} + 1}^{P} {a}_{pq} < {S}_{j} ,$$

then this vector and all descendants are infeasible.

The above procedure assumed that the solution x-vector is binary, which in general may not be practical, as more than one pack of the same type can be allocated to a store. In order to apply the solution approach to the case of general integer variables, each original integer x-variable can be expressed as:

$${x}_{pj} = {\sum }_{k = 0}^{{log}_{2} {d}_{j}} {2}^{k} {x}_{pj}^{k} , {x}_{pj}^{k} ∈ \{ 0 , 1 \} , ∀ p = 1 , … , T , j = 1 , … , D .$$

where d₁=max_{q}d_{qj}. As shown, for a given value of integer x-variable there is a single set of binary variables that satisfy the above equation.

Finally, in addition to the optimal solution for the allocation problem the algorithm can potentially return a set of all feasible allocations that can be further used to find overall optimal allocation subject to a limited single resource such as total number of packs or total buy.

As disclosed, embodiments alternatively optimize the pre-pack allocation for a given pre-pack configuration by using the store misallocation as its objective function, and based on the allocation, improves the pre-pack configuration by changing the amount of one or two products by one unit in each pre-pack. An optimized pre-pack configuration is generated when the objective function value can no longer be improved.

One embodiment systematically improves a given feasible pre-pack configuration by decreasing the total cost of product demand mismatching at each individual store in the chain, while also reducing the total shipping and handling costs. Embodiments allow the user to specify constraints such as the total and individual quantities of each product in a pre-pack as well as total product over-allocation, minimum and maximum presentation, and minimum shipping quantities per store. Each iteration of embodiments consists of two phases: In the first phase, or “allocation” phase, an allocation problem is solved for a given fixed pre-pack configuration to determine the optimal number of each pre-pack type allocated to each store to minimize the total cost subject to given constraints. At the second stage, based on the allocation obtained at the first stage, the objective function value associated with the current pre-pack configuration is improved by changing the amount of one or two products by one unit at each pre-pack. After that the algorithm reiterates until no new objective function value-improving solution can be found in the second phase.

Embodiments of the present invention do not require commercial math libraries to efficiently solve a rule-constrained business optimization problem. Further, embodiments provides a user-friendly approach to business decision optimization that is minimally disruptive. Further, embodiments, by balancing supply with the best available forecast of fine-grain demand (i.e., for each product at each store), can very closely balance supply and demand, while also keeping shipping cost to a minimum. Embodiments allow a user to input plausible demand fluctuations and thereby prevent the pre-pack design from being “keyed into” a particular demand snapshot.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to determine an optimized pre-pack solution, comprising:
(a) receive demand data and constraints;
(b) initialize a current pre-pack configuration comprising a current pre-pack design that comprises a plurality of pre-pack types, each pre-pack type comprising one or more different products;
(c) optimize a pre-pack allocation based on the current pre-pack configuration;
(d) determine an objective function value improvement comprising, for each product in each pre-pack type, change a level of the product by one unit and determine if the objective function value has improved;
(e) if the objective function value has improved, generate a new pre-pack design based on the changed level of the product;
(f) assign the new pre-pack design as the current pre-pack design;
(g) repeat (c)-(f), until the objective function value has not improved at (e);
(h) output an optimized pre-pack configuration and optimized pre-pack allocation.

2. The computer readable medium of claim 1, wherein the determine the objective function value improvement comprises incrementing by one unit and decrementing by one unit.

3. The computer readable medium of claim 1, wherein the determine the objective function value improvement comprises selecting pairs of products in each pre-pack type, and for each pair, increment one product by one unit and decrement one product by one unit.

4. The computer readable medium of claim 3, further comprising selecting a best objective function value from the change the level of the product by one unit and the increment one product by one unit and decrement one product by one unit.

5. The computer readable medium of claim 1, wherein a change of the objective function value when a product a_{pq} is increased by one unit comprises:
$${grad}_{pq}^{+} = {\sum }_{j = 1}^{D} ( {c}_{1} max ( {x}_{pj} - {y}_{jq}^{-} , 0 ) - {c}_{2} min ( {x}_{pj} , {y}_{jq}^{-} ) )$$
and wherein the change of the objective function value when the product a_{pq} is decreased by one unit comprises:
$${grad}_{pq}^{-} = {\sum }_{j = 1}^{D} ( {c}_{2} max ( {x}_{pj} - {y}_{jq}^{+} , 0 ) - {c}_{1} min ( {x}_{pj} , {y}_{jq}^{+} ) ) .$$

6. The computer readable medium of claim 5, wherein the determine the objective function value improvement comprises:
(a) for all
$$q , p : {\sum }_{q = 1}^{Q} {a}_{pq} > L ,$$
find gradₘᵢₙ=min grad_{pq}⁻; if gradₘᵢₙ<0, decrease corresponding a_{pq} by one unit;
(b) for all
$$q , p \text{:} { \sum }_{q = 1}^{Q} {a}_{pq} < U ,$$
find gradₘᵢₙ=min grad_{pq}⁺; if gradₘᵢₙ<0, increase corresponding a_{pq} by one unit;
(c) If (a) and (b) fail, find p: min_{q} grad_{pq}⁺+min_{q} grad_{pq}⁻<0; simultaneously increase a_{pq+} and decrease a_{pq-} by one unit.

7. The computer readable medium of claim 5, wherein the optimize the pre-pack allocation comprises:
$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$
$$subject to \text{:}$$
$${\sum }_{p} {a}_{pq} {x}_{pj} + {y}_{qj}^{+} - {y}_{qj}^{-} = {d}_{qj} ∀ ( q , j )$$
$${y}_{qj} \geq 0 , ∀ q , j$$
$${x}_{pj} \geq 0 and integer ∀ p , j$$
$${x}_{pj} ∈ {X}_{j} .$$

8. A computer implemented method for optimizing a pre-pack solution, the method comprising:
(a) receiving demand data and constraints;
(b) initializing a current pre-pack configuration comprising a current pre-pack design that comprises a plurality of pre-pack types, each pre-pack type comprising one or more different products;
(c) optimizing a pre-pack allocation based on the current pre-pack configuration;
(d) determining an objective function value improvement comprising, for each product in each pre-pack type, changing a level of the product by one unit and determining if the objective function value has improved;
(e) if the objective function value has improved, generating a new pre-pack design based on the changed level of the product;
(f) assigning the new pre-pack design as the current pre-pack design;
(g) repeating (c)-(f), until the objective function value has not improved at (e);
(h) outputting an optimized pre-pack configuration and optimized pre-pack allocation.

9. The computer implemented method of claim 8, wherein the determining the objective function value improvement comprises incrementing by one unit and decrementing by one unit.

10. The computer implemented method of claim 8, wherein the determining the objective function value improvement comprises selecting pairs of products in each pre-pack type, and for each pair, incrementing one product by one unit and decrementing one product by one unit.

11. The computer implemented method of claim 10, further comprising selecting a best objective function value from the changing the level of the product by one unit and the incrementing one product by one unit and decrementing one product by one unit.

12. The computer implemented method of claim 8, wherein a change of the objective function value when a product a_{pq} is increased by one unit comprises:
$${grad}_{pq}^{+} = {\sum }_{j = 1}^{D} ( {c}_{1} max ( {x}_{pj} - {y}_{jq}^{-} , 0 ) - {c}_{2} min ( {x}_{pj} , {y}_{jq}^{-} ) )$$
and wherein the change of the objective function value when the product a_{pq} is decreased by one unit comprises:
$${grad}_{pq}^{-} = {\sum }_{j = 1}^{D} ( {c}_{2} max ( {x}_{pj} - {y}_{jq}^{+} , 0 ) - {c}_{1} min ( {x}_{pj} , {y}_{jq}^{+} ) ) .$$

13. The computer implemented method of claim 12, wherein the determine the objective function value improvement comprises:
(a) for all
$$q , p : {\sum }_{q = 1}^{Q} {a}_{pq} > L ,$$
find gradₘᵢₙ=min grad_{pq}⁻; if gradₘᵢₙ<0, decrease corresponding a_{pq} by one unit;
(b) for all
$$q , p : {\sum }_{q = 1}^{Q} {a}_{pq} < U ,$$
find gradₘᵢₙ=min grad_{pq}⁺; if gradₘᵢₙ<0, increase corresponding a_{pq} by one unit;
(c) If (a) and (b) fail, find p: min_{q} grad_{pq}⁺+min_{q} grad_{pq}⁻<0; simultaneously increase a_{pq+} and decrease a_{pq-} by one unit.

14. The computer implemented method of claim 12, wherein the optimizing the pre-pack allocation comprises:
$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$
$$subject to \text{:}$$
$${\sum }_{p} {a}_{pq} {x}_{pj} + {y}_{qj}^{+} - {y}_{qj}^{-} = {d}_{qj} ∀ ( q , j )$$
$${y}_{qj} \geq 0 , ∀ q , j$$
$${x}_{pj} \geq 0 and integer ∀ p , j$$
$${x}_{pj} ∈ {X}_{j} .$$

15. A system for determining an optimized pre-pack solution for a plurality of retail stores, the system comprising:
a processor;
a computer-readable medium coupled to the processor and comprising instructions that cause the processor to:
determine a feasible pre-pack configuration;
for a current pre-pack design, optimize allocation of pre-packs to each store;
for each product q in each pre-pack p, compute a potential change in an objective function value if a current level a_{pq} is changed by ±1;
for all product pairs q₁, q₂ in each pre-pack p, compute the potential change in the objective function value if a_{pq1} is changed by −1 and a_{pq2} is changed by +1;
select a highest objective function value-improving change and a resulting new pre-pack design; and
assign the new pre-pack design as the current pre-pack design and re-optimized the allocation.

16. The system of claim 15, wherein the potential change in the objective function when the product a_{pq} is increased by one unit comprises:
$${grad}_{pq}^{+} = {\sum }_{j = 1}^{D} ( {c}_{1} max ( {x}_{pj} - {y}_{jq}^{-} , 0 ) - {c}_{2} min ( {x}_{pj} , {y}_{jq}^{-} ) )$$
and wherein the potential change in the objective function value when the product a_{pq} is decreased by one unit comprises:
$${grad}_{pq}^{-} = {\sum }_{j = 1}^{D} ( {c}_{2} max ( {x}_{pj} - {y}_{jq}^{+} , 0 ) - {c}_{1} min ( {x}_{pj} , {y}_{jq}^{+} ) ) .$$

17. The system of claim 16, wherein the select the highest objective function value-improving change and the resulting new pre-pack design comprises:
(a) for all
$$q , p : {\sum }_{q = 1}^{Q} {a}_{pq} > L ,$$
find gradₘᵢₙ=min grad_{pq}⁻; if gradₘᵢₙ<0, decrease corresponding a_{pq} by one unit;
(b) for all
$$q , p : {\sum }_{q = 1}^{Q} {a}_{pq} < U ,$$
find gradₘᵢₙ=min grad_{pq}⁺; if gradₘᵢₙ<0, increase corresponding a_{pq} by one unit;
(c) If (a) and (b) fail, find p: min_{q} grad_{pq}⁺+min_{q} grad_{pq}⁻<0; simultaneously increase a_{pq+} and decrease a_{pq-} by one unit.

18. The system of claim 15, wherein the optimize allocation of pre-packs to each store comprises:
$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$
$$subject to \text{:}$$
$${\sum }_{p} {a}_{pq} {x}_{pj} + {y}_{qj}^{+} - {y}_{qj}^{-} = {d}_{qj} ∀ ( q , j )$$
$${y}_{qj} \geq 0 , ∀ q , j$$
$${x}_{pj} \geq 0 and integer ∀ p , j$$
$${x}_{pj} ∈ {X}_{j} .$$
